(19) United States
(12) Patent Application Publication
(10) Pub. No.: US 2018/0264954 A1
(43) Pub. Date: Sep. 20, 2018

(54) AUTONOMOUS ELECTRIC AGRICULTURAL VEHICLES

(71) Applicant: OptoeV, Inc., Muncie, IN (US)

(72) Inventor: Jonathan Lamb, Muncie, IN (US)

(21) Appl. No.: 15/913,331

(22) Filed: Mar. 6, 2018

Related U.S. Application Data
(60) Provisional application No. 62/473,316, filed on Mar. 18, 2017.

(51) Int. Cl. B60L 11/18; G05D 1/00; G05D 1/02

(52) U.S. Cl. CPC B60L 11/184; B60L 11/1842; B60L 2230/22; G05D 1/0291; G05D 2201/0201; G05D 1/0088

(57) ABSTRACT

A fleet of one or more autonomous electric vehicles is provided for storing electricity and supplying electricity to an electrical grid, and performing agricultural operations, each vehicle of the multiple autonomous electric vehicles comprising: an energy system configured to store and supply electricity and configured for electrical connection with the electrical grid; a navigation system for autonomously navigating the vehicle; and an operating system configured to wirelessly receive vehicle instructions from a central system and to provide vehicle sub-system instructions to the energy system and the navigation system based on the vehicle instructions, the vehicle instructions based on at least one of electric utility grid parameters and agricultural parameters. In at least one embodiment, a single autonomous electric vehicle for storing electricity and supplying electricity to an electrical grid, and performing agricultural operations is provided.

### CROSS-REFERENCE TO RELATED APPLICATION

This application claims the benefit of priority of U.S. provisional patent application no. 62/473,316, titled “Fleet of Autonomous Electric Vehicles,” filed on Mar. 18, 2017 which is incorporated herein in its entirety by this reference.

### TECHNICAL FIELD

The present disclosure relates generally to a fleet of autonomous electric vehicles configured to store electricity from an electrical grid, supply electricity to the electrical grid and perform agricultural functions. More specifically, the present disclosure relates to a mobile fleet of autonomous electric vehicles in communication with a central control system for capitalizing on electrical grid price fluctuations when not performing agricultural functions.

### BACKGROUND

Labor for farms has long been an issue—not only is supply limited, but rising wages pressures farmers to use more mechanical equipment and automated control systems. Further, as farms consolidate and grow, there is a limited window of time for working and planting the land. To lower costs and ensure that planting occurs in this short time period, many farmers are moving towards larger equipment, such as expansive planters. This larger equipment has several drawbacks, such as cost, with tractors routinely costing hundreds of thousands of dollars. Further, the sheer size of the equipment creates logistical issues, as many country roads, bridges, and small fields limit the equipment's mobility. Due to the limited planting period, the planting equipment sits dormant for much of the year, and must be stored and maintained when not in use.

Meanwhile, the utility industry faces growing capacity issues as demand is ever-increasing and the growth of renewable energy supply sources, such as wind and solar power, continues to be limited. The daily cyclical demand of energy also strains the existing supply, creating price fluctuations for energy users.

While the technology of the prior art discloses various autonomous vehicles, as well as devices for storing and managing energy, they fail to provide a combination solution for allowing autonomous farming equipment to help alleviate the pressures on the electrical grid.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

There remains a need for small, low cost, efficient autonomous farming equipment which can continue to generate revenue when not in use by storing electricity during low demand and supplying electricity to the power grid during high demand. Disclosed herein are one or more devices and methods that advantageously address these issues. The present invention provides a solution for the utility industry and the farmer by providing a fleet of autonomous electrical vehicles capable of performing agricultural functions as needed, and, when not in agricultural use, storing electricity from the grid during low demand and supplying electricity to the grid during high demand.

According to at least one embodiment, a fleet of one or more autonomous electric vehicles is provided for storing electricity and supplying electricity to an electrical grid, and performing agricultural operations, each vehicle of the multiple autonomous electric vehicles comprising: an energy system configured to store and supply electricity and configured for electrical connection with the electrical grid; a navigation system for autonomously navigating the vehicle; and an operating system configured to wirelessly receive vehicle instructions from a central system and to provide vehicle sub-system instructions to the energy system and the navigation system based on the vehicle instructions, the vehicle instructions based on at least one of electric utility grid parameters and agricultural parameters. In at least one embodiment, a single autonomous electric vehicle for storing electricity and supplying electricity to an electrical grid, and performing agricultural operations is provided.

The electric utility grid parameters may include at least one of current prices, historical prices, and forecasted prices.

The agricultural parameters may include at least one of planting periods, navigational data, vehicle data, soil conditions, and weather conditions.

The vehicle instructions may include at least one of electrical energy storage schedules, electrical energy supply schedules, navigation schedules and navigation paths.

The central system may be configured to generate the vehicle instructions based on at least one of vehicle parameters and other parameters.

The fleet may include a central hub for housing at least one vehicle of the multiple autonomous electric vehicles. The central hub may include an operating system and an energy system.

The energy system of at least one vehicle of the multiple autonomous electric vehicles may include a power source.

At least one vehicle of the multiple autonomous electric vehicles may be coupled to a planter for planting a field.

The vehicle instructions received by the operating system of at least one vehicle of the multiple autonomous electric vehicles may instruct the at least one vehicle when to store electricity, when to supply electricity, and when to perform at least one of the agricultural operations.

According to at least one embodiment, a method of operating a fleet of autonomous electric vehicles is provided. The method includes: determining, by a central system, agricultural parameters and electrical grid parameters of an electrical grid; communicating, by the central system, vehicle-specific instructions to each particular vehicle of the fleet of autonomous electric vehicles based on the electrical grid parameters and the agricultural parameters; and operating each particular vehicle of the fleet of autonomous electric vehicles in a grid mode or an agricultural mode based on the vehicle-specific instructions of the particular vehicle. Each particular vehicle may include: an energy system configured to store and supply electricity and configured for electrical connection with the electrical grid; a navigation system for autonomously navigating the vehicle; and an operating system configured to wirelessly receive the vehicle-specific instructions from the central system and to provide vehicle sub-system instructions to the energy system and the navigation system based on the vehicle-specific instructions.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a perspective view, from a front left view point, of an autonomous electric agricultural vehicle according to at least one embodiment.

FIG. 2 is a front perspective view of the autonomous electric agricultural vehicle of FIG. 1.

FIG. 3 is a back perspective view of the autonomous electric agricultural vehicle according to of FIG. 1.

FIG. 4 is a diagrammatic representation of the vehicle 100 of FIG. 1 and several on-board subsystems.

FIG. 5 is a diagrammatic representation of an in-use fleet of vehicles, according to at least one embodiment.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

As described herein, a small, low-cost autonomous electric vehicle is provided. Further, a fleet of such vehicles may be provided, and each vehicle may be capable of autonomous navigation, equipped to perform agricultural functions, and enabled to store and supply electrical grid power. Further, each vehicle of the fleet capable may operate in coordination or independently with each other. The vehicles may be in wireless communication with a central system for coordinating, navigating and/or controlling the interaction with the electrical grid. The vehicles may be deployed to perform agricultural functions at one or more sites, may be mobilized to emergency areas for storing and providing energy as a distributed energy resource, and/or may be aggregated in one or more units to capitalize on price fluctuations within the energy grid. A fleet of vehicles as described herein refers at least to one or more vehicles. As such, one, two or more vehicles can be described as a fleet accordingly. Furthermore, a fleet can refer to multiple similar, same, or different vehicles, and supporting or related facilities, equipment, shelters, hubs, and structures.

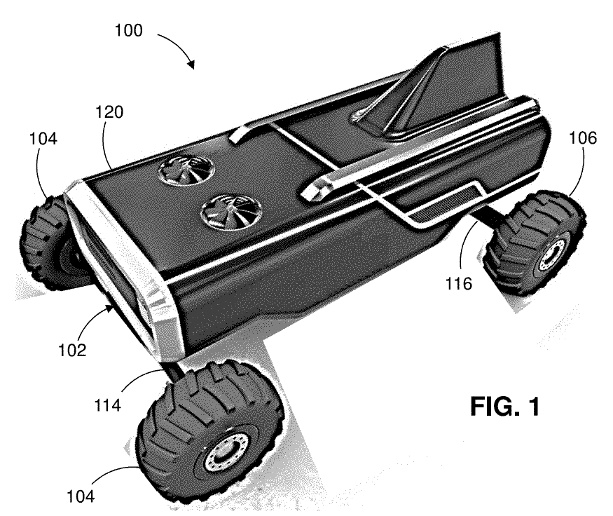

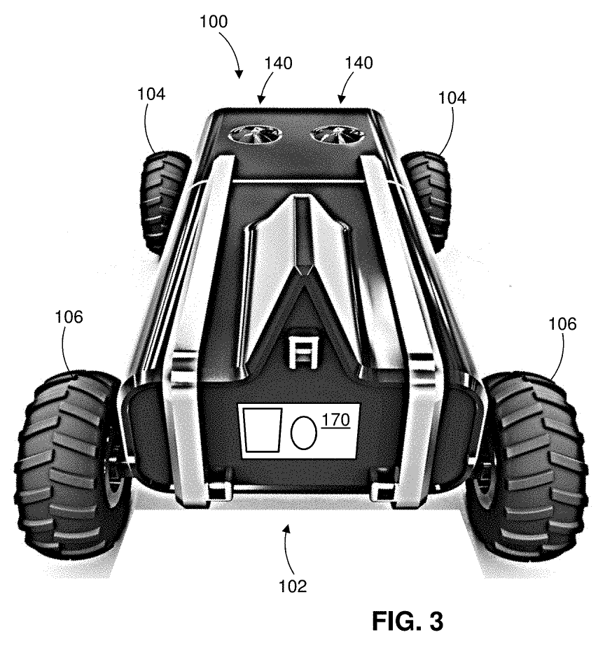

An autonomous electric agricultural vehicle 100 according to at least one embodiment is shown in FIG. 1 as an all-terrain vehicle having a main chassis 102, two forward wheels 104, and two rearward wheels 106 (FIG. 3). The vehicle 100 may have any or all of four wheel (4WD), all wheel drive (AWD), or two wheel drive (2WD) capabilities. The forward wheels 104 or the rearward wheels 106 may pivot for steering, or all wheels may have steering capability. The main chassis includes a structural frame that includes forward suspension members 114 and rearward suspension members 116 upon which the forward wheels 104, and rearward wheels 106 are mounted respectively. The suspension members 114 and 116 may be fixed or dynamic suspension elements. The body 120 shown for illustrative purposes has a generally rectangular form, shown with beveled edges and smooth contours for aerodynamic efficiency. Other configurations, for example three-wheeled and six-wheeled vehicles, and vehicles having bodies of any shape are within the scope of these descriptions.

Each vehicle 100 may be equipped with an energy system for storing electricity from the grid and supplying electricity to the grid. The energy system may also provide electricity to the vehicle for operation, navigation and/or performing agricultural functions. The energy system may provide electricity to external sources in electrical communication with the vehicle, such as through an electrical port or a wired, integration connection, enabling the vehicle to power accessories, work equipment in the field or other external sources. The energy system may be in wireless or wired communication with an operating system and/or control system and may be configured to receive instructions therefrom.

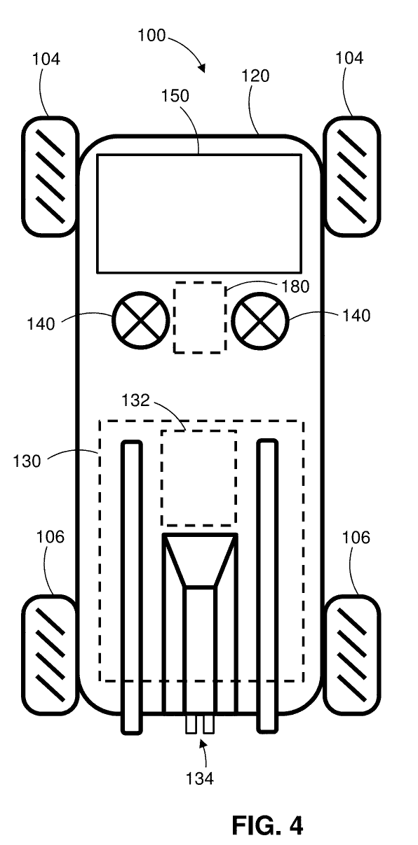

To effect these features, the energy system 130 of the vehicle 100 may include a battery or an array of batteries 132, for example housed within the body 120 as diagrammatically represented in FIG. 4, for energy storage. The energy system 130 may further include additional power sources, such as windmill(s) or solar panel(s). For example, portions or the entirety of the exterior of the body 120 may have or be solar energy harvesting panels 150 (FIG. 4). Rotary bladed devices 140 (FIG. 3) shown along the top surface of the body 120 may be active or passive cooling fans or may be wind-driven energy collectors used to charge the battery or array of batteries 132. In various embodiments, the battery or array of batteries 132 may be charged via an onboard electrical system that receives energy input from the additional power systems and stores the received energy in the battery or array of batteries 132.

The additional power sources may provide electricity to the vehicle 100, to the energy storage, or both. The energy system may simultaneously store electricity from the grid and from the additional power sources. Similarly, the energy system may supply power to the grid while simultaneously storing or receiving power from the additional power sources.

The energy system 130 of each vehicle may include one or more electrical connections 134 (FIG. 4) configured for electrical connection with the electrical grid in order to store and supply electrical grid power. Energy consuming devices such as pumps, planters, and other vehicles and other devices can receive electrical power via the one or more electrical connections 134.

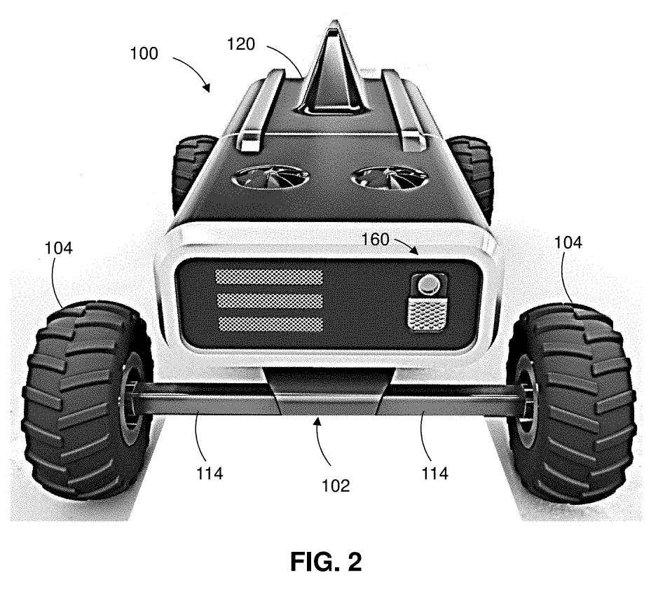

Each vehicle 100 may further include further subsystems, for example a navigation system 160 (FIG. 2) for autonomously navigating a path of the vehicle. The navigation system may be GPS-enabled. The path of each vehicle 100 may be determined based on the paths of other vehicles in the fleet, agricultural parameters, and/or instructions received from the operating system and/or control system. Agricultural parameters may include planting periods, planting area, planting schemes, navigational data, vehicle data, fleet data, soil conditions, and/or weather conditions. The paths of each vehicle 100 in a fleet may be coordinated for performing particular agricultural functions, such as continuous, round-the-clock planting.

The vehicles 100 may be equipped with further subsystems, for example an agricultural system 170 (FIG. 3) for performing agricultural functions. For example, the vehicle 100 may be equipped with connections, for example connectors 134 or others, for coupling to planting equipment, plowing equipment, or other agricultural equipment. The agricultural system may include tires, sensors, and/or vehicle body modifications specifically designed for agricultural purposes.

The vehicles may include an operating system 180 (FIG. 4) for instructing and/or controlling the energy system, the navigation system, and/or the agricultural system. The operating system 180 may receive and send instructions for interacting with the grid and performing agricultural functions. Instructions may be received from a central system.

Furthermore, the operating system 180 may determine, collect and analyze vehicle data, sensory data and received instructions. Instructions may be received and stored for later use. For example, the operating system may receive data and/or instructions when a wireless connection is available, stored the data and/or instructions, and operate using the instructions at a later time, for example when the wireless connection is not available. The operating systems of each vehicle of a fleet may communicate and receive instructions and data from each other. Further, the operating systems may, individually or in groups, be configured for wireless communication with external systems, such as agricultural equipment or other systems.

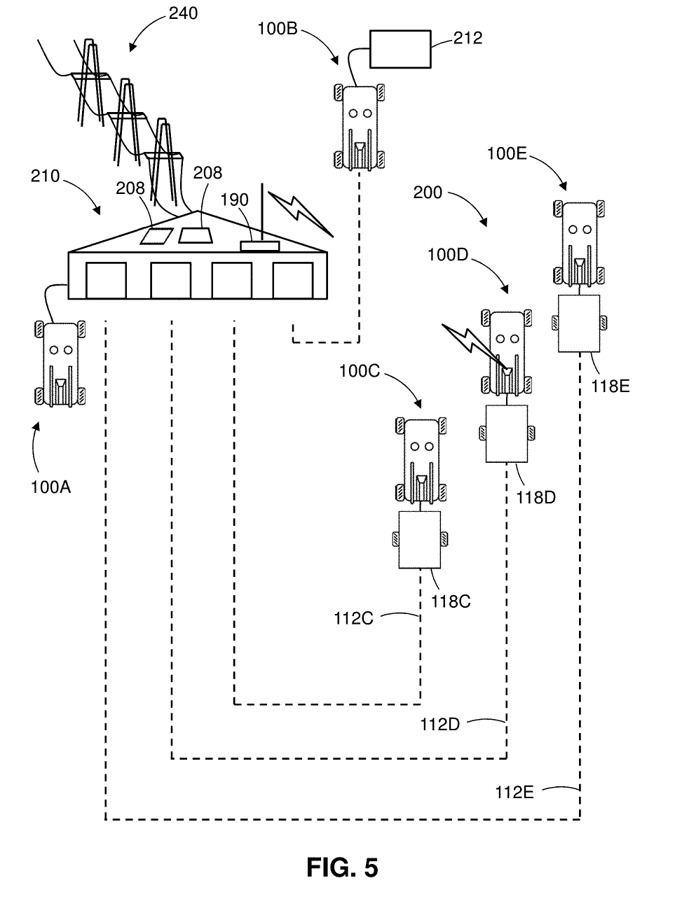

A central control system 190 (FIG. 5) may be provided to manage each vehicle of the fleet of vehicles. The central system 190 may wirelessly communicate with the operating system 180 of each vehicle. The central system may determine grid parameters and agricultural parameters, and wirelessly communicate the instructions to each vehicle based on the grid parameters and agricultural parameters. Instructions for vehicles of the fleet may include storage schedules, supply schedules, navigation schedules and/or navigation paths. Grid parameters may be provided by a utility operator and/or may include measuring real-time grid conditions. Grid parameters may also include current prices, historical prices, and/or forecasted prices.

Methods of Use: In addition to the methods described above, a fleet 200 (FIG. 5) of autonomous electric vehicles 100 may operate in coordination with the central system to continuously create value for the owner/operator. Advantageously, the central system 190 and/or operating systems 180 (FIG. 4) of the vehicles 100 may be configured to analyze and compare grid and agricultural parameters for effectively performing agricultural tasks and storing and supplying electricity to the electric utility grid 240 when not in other use, and, in some embodiments, storing electricity for later supply during use. The fleet 200 may further include a central hub 210. The central hub may include its own energy systems, operating systems, additional power sources, such as solar collectors 208, and may be in wireless communication with, or incorporate, the central system 190.

The central hub 210 may be connected to one or more vehicles 100 to operate as a distributed energy resource for both storing energy from and supplying energy to the electric utility grid 240. For example, in FIG. 5, a particular vehicle 100A is coupled to the grid 240 via the hub 210 facility to store energy from and supply energy to the grid.

In one example, the fleet of vehicles includes a first part of the fleet operating for agricultural use at Farm A, a second part of the fleet being used at Farm B, and a third part of the fleet docked at the central hub. The central system determines grid parameters for the central hub location, Farm A and Farm B. Based on these determinations, vehicles from any of the portions may be navigated to another portion to exploit advantageous grid conditions. The central system may also determine agricultural parameters for Farm A and Farm B (and any other farm). By comparing the agricultural parameters with the grid parameters, before and/or after analysis thereof, vehicles from any of the portions may be navigated to the portion offering the greatest value—whether operating as a distributed energy resource at the central hub, contributing to the agricultural operations at Farm A, or contributing to the agricultural and/or energy operations at Farm B.

In addition to the mobile transfer of vehicles between locations to take advantage of grid and agricultural parameters or conditions, the system described herein may also efficiently operate the vehicles to exploit local conditions. For example, based on the agricultural parameters at Farm A (e.g., very sunny, dry ground for faster operation of vehicle, layout of agricultural operation area), the central system may modify the agricultural schedules of some vehicles at Farm A. Some vehicles with an additional solar power source may perform agricultural operations for a longer period, permitting other vehicles to be taken offline and used as a distributed energy resource. In some cases, power stored in vehicles may be transferred to other vehicles if the determination is made that the stored power is cheaper than the grid power and vehicles are preferred to perform agricultural functions.

Analysis and comparison of various grid parameters, agricultural parameters, vehicle parameters and other parameters permit the presently disclosed invention to constantly adjust the operation of each vehicle to efficiently perform agricultural operations and grid operations in coordination. The central system and/or operating systems can compare parameters and determine which vehicles should be performing agricultural or grid operations at specific locations and specific times. For example, a vehicle 100A (FIG. 5) may store electricity during a low demand period for the electrical grid and supply electricity during a high demand period for the electricity grid. Alternatively, the vehicle may store during low demand and perform agricultural functions using the stored electricity. In yet another alternative, the vehicle may store electricity during low demand, perform agricultural functions, and supply excess electricity during high demand.

For example, in FIG. 5, a particular vehicle 100B is coupled to an energy-consuming or storing apparatus 212, such as a pump, planter, other vehicles or other device. Vehicles 100C, 100D, and 100E are shown as deployed from the hub 210 along separate respective routes 112C, 112D and 112E. For example, the operating system 180 (FIG. 4) of each vehicle can be configured to wirelessly receive vehicle instructions from the central system 190 as represented in FIG. 5, and to provide vehicle sub-system instructions to the energy system 130 and the navigation system 160 based on the vehicle instructions received from the central system. The vehicle instructions can based on at least one of electric utility grid parameters and agricultural parameters. Thus, each particular vehicle 100A-100E can be deployed to serve a different function. The vehicles 100C, 100D and 100E for example are shown in FIG. 5 as moving, positioning, and/or serving power to respective agricultural use equipment items or assets 118C, 118D and 118E, each of which may be for example a pump, a planter, a plow or tilling apparatus, a pumping or irrigating apparatus, or other vehicle.

Other alternatives would be apparent to one skilled in the art in light of the current disclosure.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A fleet of multiple autonomous electric vehicles for storing electricity and supplying electricity to an electrical grid, and performing agricultural operations, each vehicle of the multiple autonomous electric vehicles comprising:
an energy system configured to store and supply electricity and configured for electrical connection with the electrical grid;
a navigation system for autonomously navigating the vehicle; and
an operating system configured to wirelessly receive vehicle instructions from a central system and to provide vehicle sub-system instructions to the energy system and the navigation system based on the vehicle instructions, the vehicle instructions based on at least one of electric utility grid parameters and agricultural parameters.

2. The fleet of claim 1, wherein the electric utility grid parameters include at least one of current prices, historical prices, and forecasted prices.

3. The fleet of claim 1, wherein the agricultural parameters include at least one of planting periods, navigational data, vehicle data, soil conditions, and weather conditions.

4. The fleet of claim 1, wherein the vehicle instructions include at least one of electrical energy storage schedules, electrical energy supply schedules, navigation schedules and navigation paths.

5. The fleet of claim 1, wherein the central system is configured to generate the vehicle instructions based on at least one of vehicle parameters and other parameters.

6. The fleet of claim 1, further comprising a central hub for housing at least one vehicle of the multiple autonomous electric vehicles.

7. The fleet of claim 6, wherein the central hub includes an operating system and an energy system.

8. The fleet of claim 1, wherein the energy system of at least one vehicle of the multiple autonomous electric vehicles includes a power source.

9. The fleet of claim 1, wherein at least one vehicle of the multiple autonomous electric vehicles is coupled to a planter for planting a field.

10. The fleet of claim 1, wherein vehicle instructions received by the operating system of at least one vehicle of the multiple autonomous electric vehicles instructs the at least one vehicle when to store electricity, when to supply electricity, and when to perform at least one of the agricultural operations.

11. A method of operating a fleet of autonomous electric vehicles, the method comprising:
determining, by a central system, agricultural parameters and electrical grid parameters of an electrical grid;
communicating, by the central system, vehicle-specific instructions to each particular vehicle of the fleet of autonomous electric vehicles based on the electrical grid parameters and the agricultural parameters; and
operating each particular vehicle of the fleet of autonomous electric vehicles in a grid mode or an agricultural mode based on the vehicle-specific instructions of the particular vehicle,
wherein each particular vehicle comprises:
an energy system configured to store and supply electricity and configured for electrical connection with the electrical grid;
a navigation system for autonomously navigating the vehicle; and
an operating system configured to wirelessly receive the vehicle-specific instructions from the central system and to provide vehicle sub-system instructions to the energy system and the navigation system based on the vehicle-specific instructions.

12. The method of claim 11, wherein the electrical grid parameters include at least one of current prices, historical prices, and forecasted prices.

13. The method of claim 11, wherein the agricultural parameters include at least one of planting periods, navigational data, vehicle data, soil conditions, and weather conditions.

14. The method of claim 11, wherein the vehicle instructions include at least one of electrical energy storage schedules, electrical energy supply schedules, navigation schedules and navigation paths.

15. The method of claim 11, wherein the central system is configured to generate the vehicle instructions based on at least one of vehicle parameters and other parameters.

16. The method of claim 11, further comprising housing, at least sometimes, at least one of the autonomous electric vehicles in central hub.

17. The method of claim 16, wherein the central hub includes an operating system and an energy system.

18. The method of claim 11, wherein the energy system of at least one vehicle of the autonomous electric vehicles includes a power source.

19. The method of claim 11, wherein at least one vehicle of the autonomous electric vehicles is coupled to a planter for planting a field.

20. An autonomous electric vehicle for storing electricity and supplying electricity to an electrical grid, and performing agricultural operations, the vehicle comprising:
an energy system configured to store and supply electricity and configured for electrical connection with the electrical grid;
a navigation system for autonomously navigating the vehicle; and
an operating system configured to wirelessly receive vehicle instructions from a central system and to provide vehicle sub-system instructions to the energy system and the navigation system based on the vehicle instructions, the vehicle instructions based on at least one of electric utility grid parameters and agricultural parameters.
